(19) United States
(12) Patent Application Publication
(10) Pub. No.: US 2026/0146214 A1
(43) Pub. Date: May 28, 2026

(54) ANTISTATIC SOFTENING AND CLEANING DETERGENT SHEET AND PREPARATION METHOD THEREOF

(71) Applicant: Guangzhou Joyson Cleaning Products Co., Ltd., Guangzhou (CN)

(72) Inventors: Fenglei LI, Guangzhou (CN); Min SUN, Guangzhou (CN); Jieer LUO, Guangzhou (CN); Jieting YAN, Guangzhou (CN); Junli LI, Guangzhou (CN)

(21) Appl. No.: 19/078,392

(22) Filed: Mar. 13, 2025

Related U.S. Application Data
(63) Continuation of application No. PCT/CN2024/134567, filed on Nov. 26, 2024.

(51) Int. Cl. C11D 3/00; C11D 1/12; C11D 1/831; C11D 3/20; C11D 3/22; C11D 3/34; C11D 3/37; C11D 17/06

(52) U.S. Cl. CPC C11D 3/001; C11D 1/12; C11D 1/831; C11D 3/2086; C11D 3/227; C11D 3/349; C11D 3/3753; C11D 3/3769; C11D 17/06; C11D 2111/12

(57) ABSTRACT

The present application relates to an antistatic softening and cleaning detergent sheet and a preparation method thereof. The antistatic softening and cleaning detergent sheet includes a film forming agent, an anionic surfactant, a non-ionic surfactant, a softener, a conditioner, a filler, a chelating agent, an essence and water. The detergent sheet of the present application has characteristics of softening, antistatic and cleaning, is less corrosive to the production equipment and is suitable for large-scale production.

### CROSS-REFERENCE TO RELATED APPLICATION

The present application is a continuation of PCT application serial No. PCT/CN2024/134567, filed on Nov. 26, 2024. The entirety of PCT application serial No. PCT/CN2024/134567 is hereby incorporated by reference herein and made a part of this specification.

### TECHNICAL FIELD

The present application relates to a field of detergent products and, in more particular, to an antistatic softening and cleaning detergent sheet and a preparation method thereof.

### BACKGROUND ART

After a fabric is washed many times, due to alkaline components in detergents and an effect of cleaning, an inherent smoothness, extensibility and elasticity of the fiber itself are often damaged to a certain extent. As a result, the fabric appears visually wrinkled, is hard in hand feeling, and prone to generation of static electricity in dry weather. In order to solve these problems, softeners are widely used in fabric care.

Quaternary ammonium cationic surfactants and silicone softeners are common fabric softeners, but silicone softeners such as polydimethylsiloxane are not easily degraded in a natural environment, which may cause adverse effects on the ecosystem. A modified silicone softener such as amino silicone oil is easily decomposed at a high temperature, which affects an use effect and also may aggravate environmental pollution. In order to obtain a better softening effect, it is often necessary to add excessive softening agent to detergent products, and a residual excessive softening agent may cause irritation or allergic reaction to human skin.

Patent CN114517413A discloses a completely dissolvable softener sheet, which solves a problem of low load of non-woven softener sheets, but does not have a cleaning function.

In view of this, there are also some detergent products on the market that combines softening and cleaning functions, such as a softening laundry detergent and a laundry composition disclosed by patents CN108624417A and CN117363432A respectively. Although these detergent products achieve both softening and cleaning functions, because more strong cationic surfactants are used as softeners, a surface of the fabric becomes rough after the fabric is washed with these detergent products. During a production process, the strong cationic surfactants may destroy an oxide film on a surface of a production equipment, affecting a corrosion resistance of the production equipment.

Therefore, it is desired to develop a detergent product that has softening and cleaning functions and is environmentally friendly and healthy and convenient to use.

### SUMMARY

In order to solve the above problems, the present application provides an antistatic softening and cleaning detergent sheet and a preparation method thereof. The antistatic softening and cleaning detergent sheet of the present application has characteristics of softening, antistatic and cleaning, is less corrosive to the production equipment and is suitable for large-scale production.

In a first aspect, the present application provides an antistatic softening and cleaning detergent sheet and adopts the following technical solution.

An antistatic softening and cleaning detergent sheet, wherein a raw material for preparing the antistatic softening and cleaning detergent sheet includes the following components in percentage by weight: 6-35% of a film forming agent, 5-20% of an anionic surfactant, 1-10% of a non-ionic surfactant, 1-15% of a softener, 0-10% of a conditioner, 3-20% of a filler, 0.2-5% of a chelating agent, 0.5-2% of an essence, and water;
the film forming agent is polyvinyl alcohol or a mixture of polyvinyl alcohol and polyvinylpyrrolidone;
the anionic surfactant includes at least one of sodium alkyl hydroxyethyl sulfonate, lipid sodium ethoxylsulfonate and sodium fatty alcohol polyoxyethylene ether sulfate;
the non-ionic surfactant includes at least two of fatty amine polyglycerol ether, lipid ethoxylate, fatty acid glycerol ester, sucrose fatty acid ester, methyl glucose trioleate, glycerol laurate and fatty acid methyl ester ethoxylate (FMEE);
the softener selected is a weak cationic surfactant, and the softener includes at least one of sodium methyl lauryl taurate, sodium methyl cocoyl taurate, sodium lauryl sarcosinate, sodium cocoyl sarcosinate, sodium lauryl alaninate, sodium cocoyl alaninate, sodium lauryl glycinate, and sodium cocoyl glycinate.

In a complex anionic-cationic surfactant mixed system, due to a strong electrostatic attraction between cations and anions, rod-like micelles are easily formed after anionic and cationic surfactants are mixed. When a concentration is higher than a critical micelle concentration, aggregation, turbidness and phase splitting will occur, which will adversely affect a performance of the detergent sheet. In the present application, specific types of anionic surfactants, non-ionic surfactants and softeners are selected to cooperate with each other to form a special system to avoid the above problems.

Sodium alkyl hydroxyethyl sulfonate, lipid sodium ethoxylsulfonate, and sodium fatty alcohol polyoxyethylene ether sulfate contain a hydrophilic group ethoxy, which can interact with a hydrophilic moiety in a molecule of the weak cationic surfactant to form a stable mixture in water to avoid precipitation in a solution. Sodium alkyl hydroxyethyl sulfonate, lipid sodium ethoxylsulfonate, and sodium fatty alcohol polyoxyethylene ether sulfate have excellent compatibility and synergistic washing effect with the weak cationic surfactant, so as to achieve high softening and cleaning effect.

The non-ionic surfactant selected in the present application is different from a polyoxyethylene ether type non-ionic surfactant of which a structure is mainly an ether bond. For example, the hydrophilic group of fatty amine polyglycerol ether is composed of hydroxyl and ether bonds, and the hydroxyl and the ether bond appear alternately. The hydrophilicity of the fatty amine polyglycerol ether is obviously stronger than the polyoxyethylene ether type surfactant and the fatty amine polyglycerol ether has certain softening and antistatic effects on fabrics.

Further the selected softener has good emulsification, wetting, solubilization, dispersion, foaming effects, is relatively stable to acid, heat and alkali, can maintain its performance under different environmental conditions, and is mild, low-irritation, and environmentally friendliness.

In some embodiments, the raw material for preparing the antistatic softening and cleaning detergent sheet includes the following components in percentage by weight: 12.5-20% of the film forming agent, 15-20% of the anionic surfactant, 4-7% of the non-ionic surfactant, 5-10% of the softener, 1-3% of the conditioner, 3-10% of the filler, 1.5-3% of the chelating agent, 0.5-2% of the essence, and water.

In some embodiments, the film forming agent is the mixture of polyvinyl alcohol and polyvinylpyrrolidone, and a mass ratio of polyvinyl alcohol to polyvinylpyrrolidone is 3-25:1.

In some embodiments, the film forming agent is the mixture of polyvinyl alcohol and polyvinylpyrrolidone, and the mass ratio of polyvinyl alcohol to polyvinylpyrrolidone is 3-15:1.

By adopting the above technical solution, a specific film forming agent is selected and applied to a special system composed of specific anionic surfactants, non-ionic surfactants and softeners, so that the detergent sheet has good sheet forming quality, the moisture resistance and high-temperature resistance of the detergent sheet are enhanced, and the softening, antistatic and cleaning effects of the detergent sheet are given full play.

In some embodiments, the anionic surfactant is sodium alkyl hydroxyethyl sulfonate, the non-ionic surfactant is a mixture of fatty amine polyglycerol ether and fatty acid methyl ester ethoxylate, and the softener is sodium methyl lauryl taurate.

In some embodiments, in the raw material for preparing the antistatic softening and cleaning detergent sheet, a content of the sodium alkyl hydroxyethyl sulfonate is 12-18% in percentage by weight, a content of the fatty amine polyglycerol ether is 3-8% in percentage by weight, a content of the fatty acid methyl ester ethoxylate is 1-3% in percentage by weight, and a content of the sodium methyl lauryl taurate is 5-8% in percentage by weight.

By adopting the above technical solution, types of the anionic surfactant, the non-ionic surfactant and the softener are further defined, so that the special system can achieve a better synergistic state and give full play to the softening, antistatic and cleaning effects of the detergent sheet.

In some embodiments, the conditioner includes at least one of alkyl dimethyl polyoxyethylene ammonium chloride, monoalkyl dimethyl hydroxyethyl ammonium chloride, and cellulose 2-(2-hydroxy-3-(trimethylammonio) propoxy) ethyl ether chloride.

In some embodiments, the filler is a plant starch.

In some embodiments, the plant starch includes at least one of corn starch, pea starch, and tapioca starch.

In some embodiments, the chelating agent includes at least one of sodium polyaspartate, citric acid and salts thereof, gluconic acid and salts thereof.

In a second aspect, the present application provides a method for preparing the antistatic softening and cleaning detergent sheet and adopts the following technical solution.

A method for preparing the antistatic softening and cleaning detergent sheet, including the following steps:
step 1: dispersing the chelating agent in water to obtain a chelating agent dispersion liquid; dispersing the filler in water to obtain a filler dispersion liquid;
step 2: mixing the film forming agent with water at 80-90° C. until a material body of the film forming agent is swollen and completely dissolved;
step 3: adding the anionic surfactant to a resulting material from step 2, and after the anionic surfactant is completely dissolved to no mass, adding the non-ionic surfactant and completely dissolving the non-ionic surfactant;
step 4: mixing the filler dispersion liquid with a resulting material from step 3;
step 5: mixing the chelating agent dispersion liquid with a resulting material from step 4;
step 6: adding the softener to a resulting material from step 5, completely dissolving the softener to no mass and stirring continuously;
step 7: cooling a resulting material from step 6 down to 45-55° C., adding a remaining components of the raw material, adequately stirring to obtain a slurry; and
step 8: drying the slurry from step 7 at 80-120° C., and then shaping into a sheet to obtain the antistatic softening and cleaning detergent sheet.

By adopting the above technical solution, various components of the raw material are mixed in a specific order at corresponding temperatures, so that various components of the raw material can react more adequately to give full play to the detergent sheet.

In summary, the present application has the following beneficial effects:

1. In the present application, because specific anionic surfactants, non-ionic surfactants and softeners are used to form a novel special system, the problem of the complex anionic-cationic surfactant mixed system is avoided, effect sheet forming is achieved, and active ingredients will not be broken down at a high temperature during a sheet forming process, thereby ensuring efficient cleaning and softening effects and achieving an additional antistatic effect.

2. Because the special system of the present application does not use strong cationic surfactants, a damage to a dense oxide film on the surface of the production equipment is avoided and the corrosion resistance of the production equipment is not affected, thereby increasing a service life of the production equipment.

3. The special system of the present application replaces a traditional technical solution which adopts a quaternary ammonium salt type cationic surfactant and an organosilicon softener, so the special system is more conducive to the ecosystem and environmental protection, and causes no irritation or allergic reaction to human skin.

### BRIEF DESCRIPTION OF THE DRAWINGS

FIG. 1 shows a state of detergent sheets prepared in Example 1, Comparative Example 4, Comparative Example 5 and Comparative Example 7 after 24 h high-temperature resistance test.

FIG. 2 shows a corrosion of a metal surface of a production equipment by the detergent sheet prepared in Comparative Example 1.

### DETAILED DESCRIPTION

The present application is further described in detail in conjunction with the drawings and Examples below.

Raw materials used in the following Examples and comparative Examples are commercially available products.

### EXAMPLES

### Example 1

Provided was an antistatic softening and cleaning detergent sheet, and the raw material for preparing the antistatic softening and cleaning detergent sheet included the following components in percentage by weight:

15% of polyvinyl alcohol, 5% of polyvinylpyrrolidone, 10% of corn starch, 16% of sodium lauryl hydroxyethyl sulfonate, 5% of fatty acid methyl ester ethoxylate, 2% of fatty amine polyglycerol ether, 6% of sodium methyl lauryl taurate, 1.2% of cellulose 2-(2-hydroxy-3-(trimethylammonio) propoxy) ethyl ether chloride, 0.5% of alkyl dimethyl polyoxyethylene ammonium chloride, 0.3% of citric acid, 1.5% of sodium citrate, 0.5% of an essence, and the balance of deionized water.

The alkyl dimethyl polyoxyethylene ammonium chloride was purchased from Guangzhou Inno Chemicals Technology Co., LTD., model HEX25.

The fatty amine polyglycerol ether was prepared by the following preparation method.

Solid fatty amine (teteylamine, purchased from Wuhan Huaxiang Kejie Biotechnology Co., LTD., 96%) was added into a dry multi-necked flask, melted at 100° C. to a liquid state and then glycidol (purchased from Guangdong Yuanfeng Chemicals Co., LTD.) was added dropwise at a rate of 1 mL/min by stirring, wherein a molar ratio of teteylamine to glycidol was 1:6. After 12 hours of heat-holding reaction, a solid alkali catalyst was slowly added (a molar ratio of tetradecylamine to the solid alkali was 10:1) to obtain a reaction system, the reaction temperature was adjusted to 120° C. for reaction for 2 h, and the reaction system was then cooled to room temperature to obtain the fatty amine polyglycerol ether.

The solid alkali catalyst may be potassium carbonate and sodium carbonate, and potassium carbonate was used in this example.

This Example further provided a method for preparing the antistatic softening and cleaning detergent sheet, including the following steps:
Step 1: the filler and deionized water were mixed at a mass ratio of 1:1 to obtain a filler dispersion liquid for later use;
the chelating agent and deionized water were mixed at a mass ratio of 1:3 to obtain a chelating agent dispersion liquid for later use;
Step 2: the film forming agent and deionized water were mixed (a mass ratio of the film forming agent to deionized water was 1:8), heat up to 85° C., stirred at constant temperature for 45 min until a material body of the film forming agent was swollen and completely dissolved;
Step 3: the anionic surfactant was added to a resulting material from step 2 by stirring, and after the anionic surfactant was completely dissolved to no mass, the non-ionic surfactant was added by stirring and completely dissolved;
Step 4: the filler dispersion liquid was added by stirring to a resulting material from step 3;
Step 5: the chelating agent dispersion liquid was added by stirring to a resulting material from step 4;
Step 6: the softener was added by stirring to a resulting material from step 5 until the softener was completely dissolved to no mass and a resulting mixture was continuously stirred;
Step 7: after a resulting material from step 6 was cooled down to 50° C., the conditioner, the essence and the rest of water were added to the resulting material from step 6 and a resulting mixture was further stirred adequately to obtain a slurry; and
Step 8: the slurry was dried at 100° C., then shaped into a sheet, and the sheet was cut into different sizes and packed in boxes to obtain a finished product.

### Example 2

Provided was an antistatic softening and cleaning detergent sheet. This Example differs from Example 1 in the components and content of components of the raw material. Specifically, the raw material included: 10% of polyvinyl alcohol, 2.5% of polyvinylpyrrolidone, 8% of pea starch, 18% of lipid sodium ethoxylsulfonate, 5% of sodium lauryl sarcosinate, 4% of methyl glucose trioleate, 1% of fatty amine polyglycerol ether, 1.2% of cellulose 2-(2-hydroxy-3-(trimethylammonio) propoxy) ethyl ether chloride, 0.3% of gluconic acid, 2% of sodium gluconate, 0.5% of an essence and the balance of deionized water.

The lipid sodium ethoxylsulfonate was purchased from China Research Institute of Daily Chemical Industry, model SNS-80.

Further provided was a method for preparing the antistatic softening and cleaning detergent sheet and this Example differs from Example 1 in that,
in step 2, the film forming agent and deionized water were mixed (a mass ratio of the film forming agent to deionized water was 1:5), heat up to 80° C., stirred at constant temperature for 45 min until a material body of the film forming agent was swollen and completely dissolved;
in step 7, a resulting material from step 6 was cooled down to 45° C.; and
in step 8, the slurry was dried at 80° C.

### Example 3

Provided was an antistatic softening and cleaning detergent sheet and this Example differs from Example 1 in the components and content of components of the raw material. Specifically, the raw material included: 15% of polyvinyl alcohol, 5% of polyvinylpyrrolidone, 10% of cassava starch, 16% of sodium cocoyl hydroxyethyl sulfonate, 3% of glycerol laurate, 3% of sodium methyl cocoyl taurate, 3% of sodium lauryl alaninate, 1% of fatty amine polyglycerol ether, 1.2% of cellulose 2-(2-hydroxy-3-(trimethylammonio) propoxy) ethyl ether chloride, 0.3% of citric acid, 2.5% of sodium polyaspartate, 0.5% of an essence and the balance of deionized water.

Further provided was a method for preparing the antistatic softening and cleaning detergent sheet and this Example differs from Example 1 in that,
in step 2, the film forming agent and deionized water were mixed (a mass ratio of the film forming agent to deionized water was 1:10), heat up to 90° C., stirred at constant temperature for 45 min until a material body of the film forming agent was swollen and completely dissolved;
in step 7, a resulting material from step 6 was cooled down to 55° C.; and
in step 8, the slurry was dried at 120° C.

### Example 4

Provided was an antistatic softening and cleaning detergent sheet and this Example differs from Example 1 in the components and content of components of the raw material. Specifically, the raw material included: 15% of polyvinyl alcohol, 1% of polyvinylpyrrolidone, 3% of corn starch, 9% of lipid sodium ethoxylsulfonate, 9% of sodium cocoyl hydroxyethyl sulfonate, 2% of fatty acid methyl ester ethoxylate, 1% of sucrose fatty acid ester, 10% of sodium lauryl glycinate, 1% of fatty amine polyglycerol ether, 1.2% of cellulose 2-(2-hydroxy-3-(trimethylammonio) propoxy) ethyl ether chloride, 0.5% of monoalkyl dimethyl hydroxyethyl ammonium chloride, 0.3% of citric acid, 2% of sodium gluconate, 0.5% of an essence and the balance of deionized water.

### Example 5

Provided was an antistatic softening and cleaning detergent sheet. This Example differs from Example 1 in that: in the raw material for preparing the antistatic softening cleaning and detergent sheet, cellulose 2-(2-hydroxy-3-(trimethylammonio) propoxy) ethyl ether chloride and alkyl dimethyl polyoxyethylene ammonium chloride were not added and replaced with deionized water.

### Example 6

Provided was an antistatic softening and cleaning detergent sheet. This Example differs from Example 5 in that: in the raw material for preparing the antistatic softening and cleaning detergent sheet, the content of sodium methyl lauryl taurate was 10% and the content of deionized water was adjusted accordingly to ensure that the total content of the components of the raw material was 100%.

### Example 7

Provided was an antistatic softening and cleaning detergent sheet. This Example differs from Example 1 in that the raw material included: 15% of polyvinyl alcohol, 5% of corn starch, 16% of sodium lauryl hydroxyethyl sulfonate, 5% of fatty acid methyl ester ethoxylate, 1% of fatty amine polyglycerol ether, 6% of sodium methyl lauryl taurate, 1.2% of cellulose 2-(2-hydroxy-3-(trimethylammonio) propoxy) ethyl ether chloride, 0.5% of alkyl dimethyl polyoxyethylene ammonium chloride, 0.3% of citric acid, 1.5% of sodium citrate, 0.5% of an essence, and the balance of deionized water.

TABLE 1

| | | Content | | | | |
|---|---|---|---|---|---|---|
| Raw material (%) | | Example 1 | Example 2 | Example 3 | Example 4 | Example 7 |
| Film | Polyvinyl alcohol | 15 | 10 | 15 | 15 | 15 |
| forming | Polyvinylpyrrolidone | 5 | 2.5 | 5 | 1 | / |
| agent | | | | | | |
| Anionic | Sodium lauryl | 16 | / | / | / | 16 |
| surfactant | hydroxyethyl | | | | | |
| | sulfonate | | | | | |
| | Lipid sodium | / | 18 | / | 9 | / |
| | ethoxylsulfonate | | | | | |
| | Sodium cocoyl | / | / | 16 | 9 | / |
| | hydroxyethyl | | | | | |
| | sulfonate | | | | | |
| Non-ionic | Fatty acid methyl | 5 | / | / | 2 | 5 |
| surfactant | ester ethoxylate | | | | | |
| | Fatty amine | 2 | 1 | 1 | 1 | 1 |
| | polyglycerol ether | | | | | |
| | Methyl glucose | / | 4 | / | / | / |
| | trioleate | | | | | |
| | Glycerol laurate | / | / | 3 | / | / |
| | Sucrose fatty acid | / | / | / | 1 | / |
| | ester | | | | | |
| Softener | Sodium methyl lauryl | 6 | / | 3 | / | 6 |
| | taurate | | | | | |
| | Sodium lauryl | / | 5 | / | / | / |
| | sarcosinate | | | | | |
| | Sodium lauryl | / | / | 3 | / | / |
| | alaninate | | | | | |
| | Sodium lauryl | / | / | | 10 | / |
| | glycinate | | | | | |
| Conditioner | Cellulose | 1.2 | 1.2 | 1.2 | 1.2 | 1.2 |
| | 2-(2-hydroxy-3- | | | | | |
| | (trimethylammonio)propoxy) | | | | | |
| | ethyl ether | | | | | |
| | chloride | | | | | |
| | Alkyl dimethyl | 0.5 | / | / | / | 0.5 |
| | polyoxyethylene | | | | | |
| | ammonium chloride | | | | | |
| | Monoalkyl dimethyl | / | / | / | 0.5 | / |
| | hydroxyethyl | | | | | |
| | ammonium chloride | | | | | |
| Filler | Corn starch | 10 | / | / | 3 | 5 |
| | Pea starch | / | 8 | / | / | / |
| | Cassava starch | / | / | 10 | / | / |
| Chelating | Citric acid | 0.3 | / | 0.3 | 0.3 | 0.3 |
| agent | Sodium citrate | 1.5 | / | / | / | 1.5 |
| | Gluconic acid | / | 0.3 | / | / | / |
| | Sodium gluconate | / | 2 | / | 2 | / |
| | Sodium polyaspartate | / | / | 2.5 | / | / |

| | | | | | |
|---|---|---|---|---|---|
| Essence | 0.5 | 0.5 | 0.5 | 0.5 | 0.5 |
| Water | 37 | 47.5 | 39.5 | 44.5 | 48 |

### COMPARATIVE EXAMPLES

### Comparative Example 1

Provided was an antistatic softening and cleaning detergent sheet. This Comparative Example differs from Example 1 in that sodium methyl lauryl taurate was replaced by an equal amount of bisfatty alkyl ethyl hydroxyethyl methyl ammonium methylsulfate.

### Comparative Example 2

Provided was an antistatic softening and cleaning detergent sheet. This Comparative Example differs from Example 1 in that sodium methyl lauryl taurate was replaced by an equal amount of aminodimethicone.

### Comparative Example 3

Provided was an antistatic softening and cleaning detergent sheet. This Comparative Example differs from Example 1 in that sodium methyl lauryl taurate was replaced by an equal amount of polyvinyl alcohol.

### Comparative Example 4

Provided was an antistatic softening and cleaning detergent sheet. This Comparative Example differs from Example 1 in that fatty acid methyl ester ethoxylate was replaced by an equal amount of fatty alcohol polyoxyethylene ether.

### Comparative Example 5

Provided was an antistatic softening and cleaning detergent sheet. This Comparative Example differs from Example 1 in that fatty acid methyl ester ethoxylate was replaced by an equal amount of alkyl glycoside.

### Comparative Example 6

Provided was an antistatic softening and cleaning detergent sheet. This Comparative Example differs from Example 1 in that sodium lauryl hydroxyethyl sulfonate was replaced by an equal amount of sodium dodecyl sulfate.

### Comparative Example 7

Provided was an antistatic softening and cleaning detergent sheet. This Comparative Example differs from Example 1 in that the raw material included: 20% of polyvinyl alcohol (film forming agent), 15% of sodium α-olefin sulfonate (anionic surfactant), 29% of sodium dodecyl sulfate (anionic surfactant), 5% of fatty alcohol polyoxyethylene ether (non-ionic surfactant), 4% of alkyl glycoside (non-ionic surfactant), 10% of cocamidopropyl betaine (amphoteric surfactant), 10% of alkyl bishydroxyethyl methyl ammonium chloride (softener), 0.1% of sodium citrate (chelating agent), 1% of an essence and the balance of deionized water.

A method for preparing the antistatic softening and cleaning detergent sheet, including the following steps:
Step 1: the chelating agent and deionized water were mixed at a mass ratio of 1:3 to obtain a chelating agent dispersion liquid for later use;
Step 2: the film forming agent and deionized water were mixed (a mass ratio of the film forming agent to deionized water was 1:8), heat up to 85° C., stirred at constant temperature for 45 min until a material body of the film forming agent was swollen and completely dissolved;
Step 3: the anionic surfactant was added to a resulting material from step 2 by stirring, and after the anionic surfactant was completely dissolved to no mass, the non-ionic surfactant and the amphoteric surfactant were added by stirring and completely dissolved;
Step 4: the chelating agent dispersion liquid was added by stirring to a resulting material from step 3;
Step 5: the softener was added by stirring to a resulting material from step 4 until the softener was completely dissolved to no mass and a resulting mixture was continuously stirred;
Step 6: after a resulting material from step 6 was cooled down to 50° C., the essence and the rest of water were added to the resulting material from step 6 and a resulting mixture was further stirred adequately to obtain a slurry;
Step 7: the slurry was dried at 100° C., then shaped into a sheet, and the sheet was cut into different sizes and packed in boxes to obtain a finished product.

### Comparative Example 8

Provided was an antistatic softening and cleaning detergent sheet. This Comparative Example differs from Example 1 in that the raw material included: 16% of polyvinyl alcohol (film forming agent), 18% of sodium dodecyl sulfate (anionic surfactant), 8% of fatty alcohol polyoxyethylene ether (non-ionic surfactant), 5% of bisfatty alkyl ethyl hydroxyethyl methyl ammonium methylsulfate (softener), 5% of aminodimethicone (softener), 10% of corn starch (filler), 8% of zeolite (filler), 18% of bentonite (filler), 2% of sodium citrate, 0.2% of an essence and the balance of deionized water.

### Comparative Example 9

Provided was an antistatic softening and cleaning detergent sheet. This Comparative Example differs from Example 1 in that the raw material included: 6% of polyvinylpyrrolidone (film forming agent), 5% of sodium lauryl hydroxyethyl sulfonate (anionic surfactant), 6% of sodium lauryl sarcosinate (softener), 2% of fatty acid methyl ester ethoxylate (nonionic surfactant), 15% of corn starch, 1% of aminodimethicone (softener), 0.3% of citric acid, 1.5% of sodium citrate, 0.5% of an essence and the balance of deionized water.

### Comparative Example 10

Provided was an antistatic softening and cleaning detergent sheet. This Comparative Example differs from Example 7 in that alkyl bishydroxyethyl methyl ammonium chloride was replaced by an equal amount of sodium lauryl alaninate.

### Comparative Example 11

Provided was an antistatic softening and cleaning detergent sheet. This Comparative Example differs from Example 8 in that bisfatty alkyl ethyl hydroxyethyl methyl ammonium methylsulfate was replaced by an equal amount of sodium lauryl alaninate.

### Performance Test

### 1. Viscosity Test:

According to GB/T5561-2012 “Surfactants—Determination of viscosity and flow properties using a rational viscometer”, a slurry viscosity was determined at 60±0.5° C., 4 #needle, speed 6. Results are shown in Table 2.

TABLE 2

| Group | Viscosity | Forming stability |
|---|---|---|
| Example 1 | 13678 | Formable |
| Example 2 | 11676 | Formable |
| Example 3 | 11759 | Formable |
| Example 4 | 10826 | Formable |
| Example 5 | 15628 | Formable |
| Example 6 | 11012 | Formable |
| Example 7 | 12141 | Formable |
| Comparative | 15675 | Formable |
| Example 1 | | |
| Comparative | 14765 | Formable |
| Example 2 | | |
| Comparative | 13627 | Formable |
| Example 3 | | |
| Comparative | 18298 | Formable but fragile |
| Example 4 | | |
| Comparative | 10910 | Formable but fragile |
| Example 5 | | |
| Comparative | 9223 | Formable but difficult |
| Example 6 | | to dry |
| Comparative | 8682 | Formable and the surface |
| Example 7 | | film is tearable |
| Comparative | 9968 | Formable and the surface |
| Example 8 | | film is tearable |
| Comparative | 4678 | Fail to shape into a sheet |
| Example 9 | | |
| Comparative | 5267 | The slurry is thin and fail |
| Example 10 | | to shape into a sheet |
| Comparative | 6886 | The slurry is thin and fail |
| Example 11 | | to shape into a sheet |

The detergent sheets prepared in Examples 1-7 adopt a specific combination system and are less affected by amino acid surfactants (softeners).

The detergent sheets in Comparative Examples 1 and 2 were prepared by replacing the softener in Example 1 by an equal amount of a common softener. According to the results in Table 2, the specific combination system of the present application can also withstand strong cationic softeners, but the strong cationic softener will increase the viscosity of slurry. Comparative Example 3 does not use any softener component, there is little difference in slurry viscosity compared with Example 1, indicating that the specific combination system of the present application is compatible with amino acid surfactants (softeners). For other combination systems of Comparative Examples 10 and 11, the addition of amino acid surfactants can reduce the viscosity of slurry. However, if the viscosity is too low, the slurry can not be dried and shaped into a sheet. Comparative Examples 4-6 were obtained by replacing the anionic and non-ionic surfactants in Example 1 with other anionic and non-ionic surfactants in equal amounts. It was found that the slurry in Comparative Examples 4-5 had higher viscosity and could be shaped into a sheet successfully; however, the quality of the detergent sheet was poor, the sheet was fragile, and debris and fragments were easily generated during the cutting process.

### 2. Moisture Stability Test

According to QB/T5779-2023 “Laundry sheet”, a box of detergent sheets (containing detergent sheets stacked up and down) was placed in a test environment with a temperature of (25±2° C.) and relative humidity of (85±5) %. Four groups were set for the test. After 24 hours, one group was taken out, and then two detergent sheets were separated to observe whether there was adhesion between the two detergent sheets.

### 3. High-Temperature Test:

The detergent sheets were placed in a test environment with a temperature of 55±2° C. for 24 h, the detergent sheets were bent and folded in half to observe whether the detergent sheets have creases or cracks. Results are shown in Table 3.

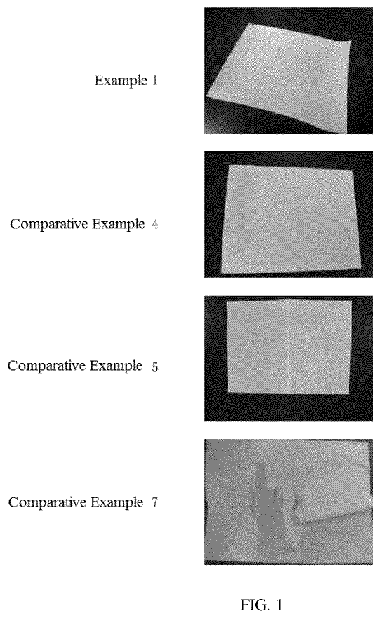

For a state of the detergent sheets prepared in Example 1, Comparative Example 4, Comparative Example 5 and Comparative Example 7 after 24 h high-temperature resistance test, please refer to FIG. 1.

TABLE 3

| | | | 24 h high- | |
|---|---|---|---|---|
| | | | temperature test | |
| | 24 h moisture | | Surface | |
| | stability | | integrity | |
| | | Determi- | after | Determi- |
| Group | Adhesion | nation | bending | nation |
| Example 1 | N/A | Qualified | No cracks | Qualified |
| Example 2 | N/A | Qualified | No cracks | Qualified |
| Example 3 | N/A | Qualified | No cracks | Qualified |
| Example 4 | N/A | Qualified | No cracks | Qualified |
| Example 5 | N/A | Qualified | No cracks | Qualified |
| Example 6 | N/A | Qualified | No cracks | Qualified |
| Example 7 | N/A | Qualified | No cracks | Qualified |
| Comparative | Adhered | Not | No cracks | Qualified |
| Example 1 | | qualified | | |
| Comparative | Adhered and | Not | No cracks | Not |
| Example 2 | greasy | qualified | and greasy | qualified |
| Comparative | N/A | Qualified | No cracks | Qualified |
| Example 3 | | | | |
| Comparative | N/A | Qualified | Cracked | Not |
| Example 4 | | | | qualified |
| Comparative | N/A | Qualified | Cracked | Not |
| Example 5 | | | | qualified |
| Comparative | Adhered | Not | No cracks | Qualified |
| Example 6 | | qualified | | |
| Comparative | Adhered | Not | The surface | Not |
| Example 7 | | qualified | film peels off | qualified |
| Comparative | Adhered | Not | The surface | Not |
| Example 8 | | qualified | film peels off | qualified |

Although the slurry in Comparative Examples 1 and 2 can be shaped into a sheet, it can be seen from the test results in Table 3 that the detergent sheets prepared in Comparative Examples 1 and 2 has poor moisture stability, poor high-temperature resistance and poor sheet quality.

### 4. Antistatic Performance Test for Fabric Conditioners:

The test was carried out according to GB/T16801-2013 “Determination of antistatic performance for fabric conditioners”. A test concentration of the detergent sheets to be tested was 2.5 g/L, and a detergent sheet will be regarded as qualified when the Logarithmic difference of surface-specific resistance Δlgρs≥2.5. The test polyester cloth was purchased from the China Research Institute of Daily Chemical Industry. Results are shown in Table 4.

TABLE 4

| | | | Logarithmic value of | |
|---|---|---|---|---|
| | | | fabric surface-specific | |
| Name of | Sample | | resistance (antistatic | |
| sample | concentration | | performance) Δlgps | Result |
| Example 1 | 2.5 | g/L | 3.8 | Qualified |
| | 10 | g/L | 4.6 | Qualified |
| Example 2 | 2.5 | g/L | 3.1 | Qualified |
| | 10 | g/L | 4.3 | Qualified |
| Example 3 | 2.5 | g/L | 3.5 | Qualified |
| | 10 | g/L | 4.2 | Qualified |
| Example 4 | 2.5 | g/L | 3.9 | Qualified |
| | 10 | g/L | 4.7 | Qualified |
| Example 5 | 2.5 | g/L | 2.9 | Qualified |
| | 10 | g/L | 3.5 | Qualified |
| Example 6 | 2.5 | g/L | 3.0 | Qualified |
| | 10 | g/L | 4.1 | Qualified |
| Example 7 | 2.5 | g/L | 3.7 | Qualified |
| | 10 | g/L | 4.5 | Qualified |
| Comparative | 10 | g/L | 3.4 | Qualified |
| Example 1 | | | | |
| Comparative | 10 | g/L | 3.9 | Qualified |
| Example 2 | | | | |
| Comparative | 10 | g/L | 1.7 | Not |
| Example 3 | | | | qualified |
| Comparative | 10 | g/L | 2.3 | Not |
| Example 4 | | | | qualified |
| Comparative | 10 | g/L | 2.1 | Not |
| Example 5 | | | | qualified |
| Comparative | 10 | g/L | 2.0 | Not |
| Example 6 | | | | qualified |
| Comparative | 10 | g/L | 3.6 | Qualified |
| Example 7 | | | | |
| Comparative | 10 | g/L | 3.2 | Qualified |
| Example 8 | | | | |

### 5. Surface Roughness Test:

A surface roughness tester was used to test the surface roughness of the washed polyester cloth, and a pointer with a diameter of 10 μm was selected for a soft material. Four samples of each item were selected for testing. Results are shown in Table 5.

### 6. Subjective Evaluation of Fabric Touch Feeling:

According to Appendix A of FZ/T01171-2023 “Textiles—Testing and evaluation of fabric touch feeling—Three-point beam method”, the surface roughness of washed fabrics was evaluated and scored on a 100-point scale: ≤59 is classified as very rough, 60-69 as rough, 70-80 as less smooth, 81-90 as smooth, and 91-100 as very smooth. Unwashed polyester cloth was used as a control. Results are shown in Table 5.

TABLE 5

| | | | | Subjective evaluation |
|---|---|---|---|---|
| Name of | Sample | | Fabric surface | of Fabric |
| sample | concentration | | roughness μm | touch feeling |
| Example 1 | 2.5 | g/L | 7.4 | 84 smooth |
| | 10 | g/L | 6.8 | 89 smooth |
| Example 2 | 2.5 | g/L | 8.1 | 82 smooth |
| | 10 | g/L | 7.7 | 86 smooth |
| Example 3 | 2.5 | g/L | 7.5 | 81 smooth |
| | 10 | g/L | 6.4 | 85 smooth |
| Example 4 | 2.5 | g/L | 7.3 | 85 smooth |
| | 10 | g/L | 6.2 | 90 smooth |
| Example 5 | 2.5 | g/L | 8.6 | 81 smooth |
| | 10 | g/L | 8.0 | 85 smooth |
| Example 6 | 2.5 | g/L | 7.8 | 82 smooth |
| | 10 | g/L | 7.2 | 88 smooth |
| Example 7 | 2.5 | g/L | 7.6 | 86 smooth |
| | 10 | g/L | 6.9 | 89 smooth |
| Comparative | 10 | g/L | 15.3 | 63 rough |
| Example 1 | | | | |
| Comparative | 10 | g/L | 14.9 | 65 rough |
| Example 2 | | | | |
| Comparative | 10 | g/L | 31.5 | 50 very |
| Example 3 | | | | rough |
| Comparative | 10 | g/L | 21.8 | 75 less |
| Example 4 | | | | smooth |
| Comparative | 10 | g/L | 20.9 | 77 less |
| Example 5 | | | | smooth |
| Comparative | 10 | g/L | 22.1 | 72 less |
| Example 6 | | | | smooth |
| Comparative | 10 | g/L | 27.2 | 62 rough |
| Example 7 | | | | |
| Comparative | 10 | g/L | 23.6 | 67 rough |
| Example 8 | | | | |

### 7. Detergency Test

According to GB/T13174-2021 “Determination of detergency and cycle of washing property for laundry detergents”, detergency was test, wherein the washing water was hard water (CaCl₂): 250 mg/kg), and the test cloth was the national standard carbon black JB-01 dirty cloth, the national standard protein JB-02 dirty cloth, the national standard sebum JB-03 dirty cloth.

Using 0.2% standard laundry detergent as control, the detergency ratio Pi was obtained, wherein Pi≥1.0 was determined as qualified and Pi<1.0 was determined as unqualified. Results are shown in Table 6.

TABLE 6

| | | | | | Determination |
|---|---|---|---|---|---|
| Group | Concentration | JB-01 | JB-02 | JB-03 | result |
| Example 1 | 0.2% | 1.05 | 1.19 | 1.12 | Qualified |
| Example 2 | 0.2% | 1.07 | 1.17 | 1.10 | Qualified |
| Example 3 | 0.2% | 1.09 | 1.29 | 1.00 | Qualified |
| Example 4 | 0.2% | 1.00 | 1.44 | 1.35 | Qualified |
| Example 5 | 0.2% | 1.11 | 1.35 | 1.09 | Qualified |
| Example 6 | 0.2% | 1.08 | 1.29 | 1.27 | Qualified |
| Example 7 | 0.2% | 1.07 | 1.18 | 1.15 | Qualified |
| Comparative | 0.2% | 0.89 | 1.02 | 1.00 | Not |
| Example 1 | | | | | qualified |
| Comparative | 0.2% | 0.90 | 1.21 | 1.07 | Not |
| Example 2 | | | | | qualified |
| Comparative | 0.2% | 1.08 | 1.16 | 1.14 | Qualified |
| Example 3 | | | | | |
| Comparative | 0.2% | 0.93 | 1.18 | 1.03 | Not |
| Example 4 | | | | | qualified |
| Comparative | 0.2% | 0.96 | 1.07 | 1.02 | Not |
| Example 5 | | | | | qualified |
| Comparative | 0.2% | 0.93 | 1.12 | 0.90 | Not |
| Example 6 | | | | | qualified |
| Comparative | 0.2% | 0.90 | 0.98 | 0.97 | Not |
| Example 7 | | | | | qualified |
| Comparative | 0.2% | 0.91 | 1.11 | 1.07 | Not |
| Example 8 | | | | | qualified |

Compared with Comparative Example 3, Example 1 has little change in detergency, indicating that the use of the amino acid surfactant as a main softener does not cause mutually exclusive phenomenon between the softening effect and detergency. Although the sheet was shaped in Comparative Example 1, the detergency of the detergent sheet in Comparative Example 1 is inferior to that in Comparative Example 3, indicating that some strong cationic softeners generate electrostatic absorption to anionic surfactants, causing reduction in the detergency.

Comparative Examples 4 and 5 were obtained by replacing the nonionic surfactant in Example 1, and Comparative Example 6 was obtained by replacing the anionic surfactant in Example 1. According to the above test results, the breakdown of the special construction system has a great influence on the detergency and antistatic performance of the detergent sheet.

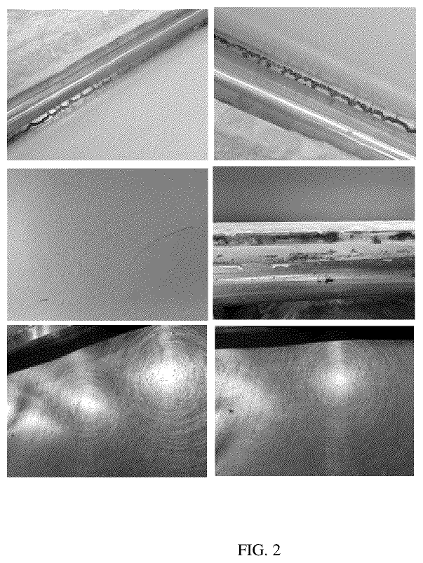

For the corrosion of a metal surface of a sheet production equipment by the detergent sheet prepared in Comparative Example 1, please refer to FIG. 2.

These specific examples are only an understanding of the present application, but not for limiting the present application. After reading this specification, those skilled in the art may made modifications to the examples without creative contribution as needed, and the modifications shall be protected by the patent law as long as they fall within the scope of the claims of the present application.

What is claimed is:

1. An antistatic softening and cleaning detergent sheet, wherein a raw material for preparing the antistatic softening and cleaning detergent sheet comprises the following components in percentage by weight: 6-35% of a film forming agent, 5-20% of an anionic surfactant, 1-10% of a non-ionic surfactant, 1-15% of a softener, 0-10% of a conditioner, 3-20% of a filler, 0.2-5% of a chelating agent, 0.5-2% of an essence, and water;
the film forming agent is polyvinyl alcohol or a mixture of polyvinyl alcohol and polyvinylpyrrolidone;
the anionic surfactant comprises at least one of sodium alkyl hydroxyethyl sulfonate, lipid sodium ethoxylsulfonate or sodium fatty alcohol polyoxyethylene ether sulfate;
the non-ionic surfactant comprises at least two of fatty amine polyglycerol ether, lipid ethoxylate, fatty acid glycerol ester, sucrose fatty acid ester, methyl glucose trioleate, glycerol laurate or fatty acid methyl ester ethoxylate (FMEE); and
the softener comprises at least one of sodium methyl lauryl taurate, sodium methyl cocoyl taurate, sodium lauryl sarcosinate, sodium cocoyl sarcosinate, sodium lauryl alaninate, sodium cocoyl alaninate, sodium lauryl glycinate, or sodium cocoyl glycinate.

2. The antistatic softening and cleaning detergent sheet according to claim 1, wherein the raw material for preparing the antistatic softening and cleaning detergent sheet comprises the following components in percentage by weight: 12.5-20% of the film forming agent, 15-20% of the anionic surfactant, 4-7% of the non-ionic surfactant, 5-10% of the softener, 1-3% of the conditioner, 3-10% of the filler, 1.5-3% of the chelating agent, 0.5-2% of the essence, and the water.

3. The antistatic softening and cleaning detergent sheet according to claim 1, wherein the film forming agent is the mixture of polyvinyl alcohol and polyvinylpyrrolidone, and a mass ratio of polyvinyl alcohol to polyvinylpyrrolidone is 3-25:1.

4. The antistatic softening and cleaning detergent sheet according to claim 1, wherein the anionic surfactant is the sodium alkyl hydroxyethyl sulfonate, the non-ionic surfactant is a mixture of the fatty amine polyglycerol ether and the fatty acid methyl ester ethoxylate, and the softener is the sodium methyl lauryl taurate.

5. The antistatic softening and cleaning detergent sheet according to claim 4, wherein in the raw material for preparing the antistatic softening and cleaning detergent sheet, a content of the sodium alkyl hydroxyethyl sulfonate is 12-18% in percentage by weight, a content of the fatty amine polyglycerol ether is 3-8% in percentage by weight, a content of the fatty acid methyl ester ethoxylate is 1-3% in percentage by weight, and a content of the sodium methyl lauryl taurate is 5-8% in percentage by weight.

6. The antistatic softening and cleaning detergent sheet according to claim 1, wherein the conditioner comprises at least one of alkyl dimethyl polyoxyethylene ammonium chloride, monoalkyl dimethyl hydroxyethyl ammonium chloride, and cellulose 2-(2-hydroxy-3-(trimethylammonio) propoxy) ethyl ether chloride.

7. The antistatic softening and cleaning detergent sheet according to claim 1, wherein the filler is a plant starch.

8. The antistatic softening and cleaning detergent sheet according to claim 7, wherein the plant starch comprises at least one of corn starch, pea starch, or tapioca starch.

9. The antistatic softening and cleaning detergent sheet according to claim 1, wherein the chelating agent comprises at least one of sodium polyaspartate, citric acid and salts of the citric acid, or gluconic acid and salts of the gluconic acid.

10. A method for preparing the antistatic softening and cleaning detergent sheet according to claim 1, comprising the following steps:
step 1: dispersing the chelating agent in water to obtain a chelating agent dispersion liquid; dispersing the filler in water to obtain a filler dispersion liquid;
step 2: mixing the film forming agent with water at 80-90° C. until a material body of the film forming agent is swollen and completely dissolved;
step 3: adding the anionic surfactant to a resulting material from the step 2, and after the anionic surfactant is completely dissolved to no mass, adding the non-ionic surfactant and completely dissolving the non-ionic surfactant;
step 4: mixing the filler dispersion liquid with a resulting material from the step 3;
step 5: mixing the chelating agent dispersion liquid with a resulting material from the step 4;
step 6: adding the softener to a resulting material from the step 5, completely dissolving the softener to no mass and stirring continuously;
step 7: cooling a resulting material from the step 6 down to 45-55° C., adding remaining components of the raw material, and stirring to obtain a slurry; and
step 8: drying the slurry from the step 7 at 80-120° C., and then shaping into a sheet to obtain the antistatic softening and cleaning detergent sheet.
